(19) United States
(12) Patent Application Publication
(10) Pub. No.: US 2008/0083575 A1
(43) Pub. Date: Apr. 10, 2008

(54) EXTERNAL AIR SCOOP FOR INTERNAL COMBUSTION ENGINE AIR INTAKE OF AN AUTOMOBILE

(75) Inventor: Robert J. Smith, Edinboro, PA (US)

Correspondence Address: BLYNN L. SHIDELER;THE BLK LAW GROUP, 3500 BROKKTREE ROAD, SUITE 200, WEXFORD, PA, 15090, US

(73) Assignee: MESSERSCHMITT DESIGN LTD., Edinboro, PA (US)

(21) Appl. No.: 11/697,761

(22) Filed: Apr. 9, 2007

Related U.S. Application Data
(60) Provisional application No. 60/744,443, filed on Apr. 7, 2006.

(51) Int. Cl. B60K 13/02

(52) U.S. Cl. 180/68.3

(57) ABSTRACT

An external air scoop for an automobile having front and rear wheels and an internal combustion engine within a forward engine compartment having a hood for access to the engine compartment, and having an air intake for the engine, the air scoop coupled to the air intake and having an air inlet positioned laterally of the hood and generally above the front wheel of the automobile.

### CROSS REFERENCE TO RELATED APPLICATION

The present application claims the benefit of U.S. provisional patent application Ser. No. 60/744,443, entitled “EXTERNAL AIR SCOOP FOR INTERNAL COMBUSTION ENGINE AIR INTAKE OF AN AUTOMOBILE” filed on Apr. 7, 2006.

### BACKGROUND OF THE INVENTION

1. Field of the Invention

The present invention relates to an external air scoop for the air intake of the internal combustion engine of an automobile, and more particularly, the present invention is directed to an external air scoop for the air intake of the internal combustion engine of an automobile that has an inlet which is positioned generally laterally of the hood and generally above the front wheel of the automobile.

2. Background Information

In the internal combustion engines normally found in automobiles one manner for improving engine performance is improving the air intake system. As an internal-combustion engine requires approximately 14.7 parts of air for each part of gasoline in the combustion chamber, getting enough “quality air” to the engine is essential. The term “quality air” refers to air that is “clean” and “cool”.

Clean air is air that is substantially free of dust and other foreign materials in the engine that could cause excessive wear and operating problems. Air cleaners or filters are made to separate dust and other particles in the incoming air before it enters the carburetor. One of the easiest and cheapest modifications to many automobiles is to replace the stock paper air filter element that is standard on most vehicles with a high performance air filter. Hot Rod magazine tested a typical high performance air filter compared with the standard air filter provided in a 1996 Ford Mustang and found a 5 BHP increase at the wheels. Most of the horsepower gains are at higher RPMs when the engine really benefits from the less-restrictive air flow. While not a tremendous power gain, the filters' relatively low cost and ease of installation (about 5 minutes) make this an attractive modification for improving automobile performance.

The second preference for air intake for the engine is to provide cool air. The colder that the air is, the more dense the air is, and denser air will provide more oxygen in any given volume (i.e. inside the engine cylinder), allowing the engine to burn more fuel and generate more power. One rule of thumb is that a decrease in the air intake temperature of about 10 degrees F. will increase horsepower and torque by about 1%. The converse is also true. One problem with many automobile stock engine air intake systems is that they consist of essentially just a box with a filter located somewhere in the engine compartment where it can be fit. This box draws in the hot air from under the car's hood and is not in the best place to draw cooler air. Aftermarket internal “short ram” air intakes, which resemble a cone on a pipe, can provide a few more extra horsepower; however, these internal systems suffer from the same problem as stock systems in that they draw in the under-hood air. Therefore, they work nicely after the car has been sitting overnight, but actually decrease in performance once the engine (and thus under-hood temperature) heats up.

One visually interesting technique is for getting external air (i.e. non-engine compartment air) to the engine is to move the entire air filter & carburetor assembly out from under the hood. The most common examples are “Shaker hoods” where the air filter, usually in a protective and decorative cover, physically juts out of the hood through a hole in the hood. Thus, the air is drawn directly from the outside, without having to go through any piping. It is called a Shaker hood because the air filter cover actually can be seen shaking as the engine vibrates. This technique also has a greater benefit the higher off of the hood that the air inlets are located. Many high performance race cars use this technique and, with carburetor risers, often have intake systems 6″-10″ higher than the rest of the hood. The shaker hood represents one example of a true cold air induction system in that the air for combustion is drawn from external to the engine compartment.

A second true cold air induction system was pioneered by Pontiac, as discussed below, and is commonly called “Ram Air”. The typical ram air design is to draw air from the outside of the engine compartment either through holes in the hood, or through openings in the grille, or bumper and into air ducts that channel the air through the air filter and into the carburetor. In almost all ram air cases, the carburetor is sealed off from getting any air from within the engine compartment.

Oftentimes, the hood vents will actually be scoops that are raised from the rest of the hood, to capture air as it flows over the hood. Performance can be increased if these scoops are at least 1″ above the surface of the hood to move the air intake past the boundary layer of air surrounding the automobile in motion. Thus, the air flowing over the hood is “rammed” into the scoops, through the air ducts, and into the engine. While most scoops either point forward on the hood, Chevrolet pioneered their “Cowl Induction” system which featured a backward facing “scoop” right at the base of the windshield. This “scoop” actually received air that was forced backwards after hitting the windshield. Within the meaning of the present application the term air scoop or scoop will reference an air intake for an internal combustion engine of a vehicle that extends at least 1″ beyond the body surface of the automobile. The term “scoop” is in contrast with air intake channels that pull external air into grooves or channels formed in the automobile body such as found in the behind the door air intake channels in the Ferrari 328. Other articles can be found that refer to these channels as “Air Scoops”, however such designations seem inappropriate and miss-descriptive of the function as they do not extend beyond the boundary layer and hence fail to “scoop” the air. External air intake system running from the front grill or headlight area or other front end positioning are also known and are sometimes called scoops, again these air intake designs are not considered a “scoop” within the meaning of this application as the air inlets in these systems do not extend out beyond the body surface of the vehicle.

While it would be several more years before becoming available as a production option and officially designated “Ram Air” by Pontiac, the 1965 air scoop package for the GTO was likely the first commercial cold-air induction system. The idea of tamping cold air into a high-performance engine had already been well proven on the drag strip as Pontiac team racers had installed scoops on the hoods of their 1962 Super Duty Catalinas. When the GTO was introduced, testing was already under way on developing a cold-air package for the street. Due to the design of the 1964 GTO's hood-scoop ornaments, which flanked each side of the hood line and were more scalloped than scooped, a cowl-induction setup was tested and abandoned. With the proposed dual-quad setup for the 1965 GTO, a new scoop design was devised, placing the bubble at the hood centerline and capping the opening with a pot-metal ornament retained by three speed nuts. This hood would be standard on all GTOs. Dual-quad cars would be available with a cold-air package, consisting of a metal tub or “pan” installed on the carburetors, taking the place of the air-cleaner base. The outer edges of the tub would curl upward and be lined with a thick rubber gasket that, when the hood was closed, would seal out the hot under hood air. The solid ornament would be replaced by an open unit that allowed outside air to be “rammed” into the carburetors under wide-open throttle to increase horsepower. When the dual-quad option was canceled, a decision was made to leave the hood on the car with the closed ornament installed. This was, however, not the end of the cold-air package. Thanks to testing conducted by Royal Pontiac and Pontiac Engineering, a new air-scoop accessory package was released on Aug. 17, 1965. Available to dealers to sell over the counter, the $49.50 package (part number 984716) was designed to fit the Tri-Power induction setup and consisted of the tub, gasket, a closed scoop ornament and instructions on removing the rear section of the forward hood bracing and opening the replacement ornament. The design and construction of the components was similar to the ill fated dual-quad cold-air package.

In the over forty years since their commercial introduction their have been a number of scoop designs. A number of hood scoop designs have been proposed. There are a number of recognized problems with many existing hood scoop designs. The first is that the opening will increase engine noise and this can be an issue where local law limits vehicle engine noise emission. A second issue is hood scoops are located where they can collect and allow access to debris and water. A third issue is length of the intake, because the longer the intake system, the less effective the result as the incoming air will heat up as it travels to the engine.

It is the objects of the present invention to address the deficiencies of the prior art and provide an effective, efficient external air scoop.

### SUMMARY OF THE INVENTION

It is noted that, as used in this specification and the appended claims, the singular forms “a,” “an,” and “the” include plural referents unless expressly and unequivocally limited to one referent. The various embodiments and examples of the present invention as presented herein are understood to be illustrative of the present invention and not restrictive thereof and are non-limiting with respect to the scope of the invention.

In one non-limiting aspect of the present invention provides an external air scoop for an automobile. The automobile has front and rear wheels, an internal combustion engine within a forward engine compartment having a hood for access to the engine compartment, and an air intake for the engine. The air scoop is coupled to the air intake and has an air inlet positioned generally laterally of the hood and generally above the front wheel of the automobile.

These and other advantages of the present invention will be clarified in the description of the preferred embodiments taken together with the attached figures.

### BRIEF DESCRIPTION OF THE DRAWINGS

FIG. 1 is a schematic front view of an automobile with an external air scoop according to the present invention;

FIG. 2 is a schematic plan view of a front portion of the automobile of FIG. 1;

FIG. 3 is a schematic front view of another automobile with an external air scoop according to the present invention; and

FIG. 4 is a schematic front view of the automobile of FIG. 3.

### DESCRIPTION OF THE PREFERRED EMBODIMENTS

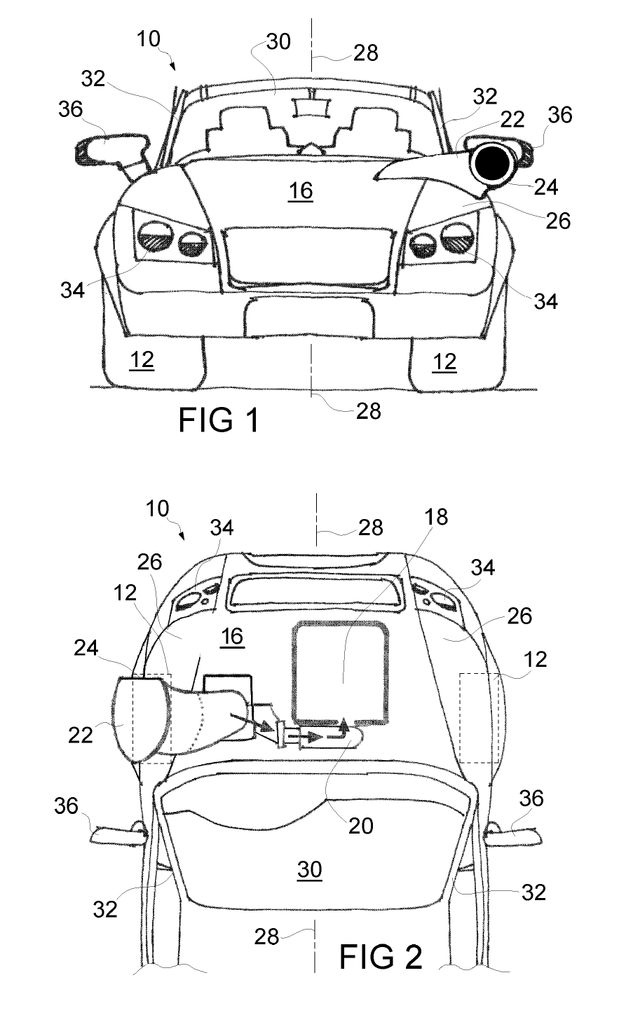

The present invention, in accordance with one aspect thereof, provides an automobile 10 (FIGS. 1 and 2) having front wheels 12 and rear wheels 14 (not shown in FIGS. 1-2). The wheels 12 and 14 are driven and steered in a conventional fashion as known in the art. The wheels 12 and 14 are mounted on a frame (not shown) that is covered by a vehicle body as is generally known in the art. The automobile 10 can be alternatively referred to herein as a vehicle or car without changing the scope of what is being referred to.

The vehicle body defines a forward engine compartment having a hood 16 for access to the engine compartment. An internal combustion engine 18 mounted to the frame of the automobile 10 and is positioned within the engine compartment. The details of the internal combustion engine 18, hood 16 construction and mounting and particulars of the engine compartment in general are known to those of ordinary skill in the art.

An air intake system is coupled to the engine 18 and includes internal conduits 20 within the engine compartment that are coupled with an external housing 22 that extends outside the engine compartment. The housing 22 forms an air scoop having an air inlet 24 positioned laterally of the hood 16 and generally above the front wheel 12 of the automobile 10 as shown. The air inlet 24 is a forward facing round opening at the distal end of the housing 22. The preferred round shape of the inlet 24 may be circular as shown, or oval or elliptical. Further, instead of facing exactly forward the air inlet 24 could be angled to improve performance, such as angled downward to minimize water inlet. In order to angle the inlet 24 down the top portion of the housing 22 forming the inlet 24 need only extend slightly beyond the bottom thereof. An “angling” of the entire housing 22 is not required to adjust the orientation of the inlet 24. A vertical centerline of the inlet 24 is spaced at least 2 inches from the body. The inlet 24 is preferably spaced 2-4 inches from the body, represented by body panel 26 in FIGS. 1-2. In other words the closest part of the opening forming the inlet 24 is 2-4 inches from the panel 26. As noted above the term air scoop or scoop will reference an air inlet such as inlet 24 for an internal combustion engine such as engine 18 of a vehicle such as automobile 10 that extends at least 1″ beyond the body surface of the automobile, here the inlet 24 begins, preferably, at least 2-4 inches from the body and extends much further.

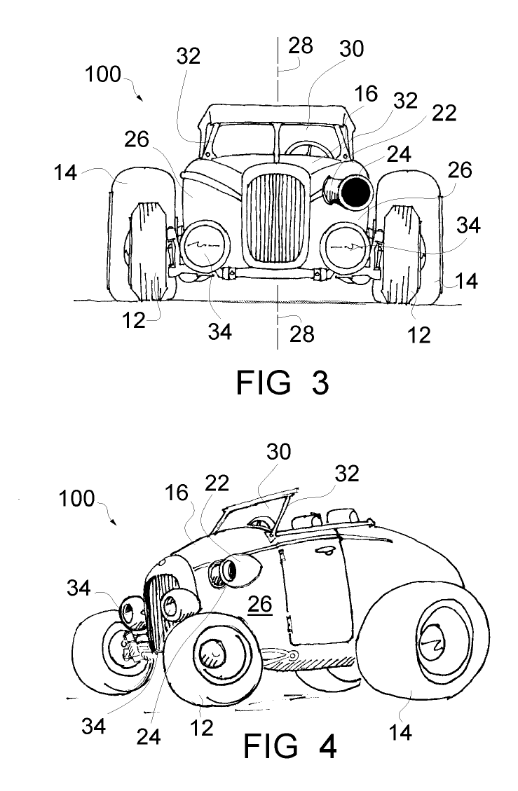

The automobile 10 defines a center plane 28, and a front end which is the end nearest the front tires 14, a rearward end (not shown), a top shown in plan view, and lateral sides. The phrase defining that “the air inlet 24” is “positioned laterally of the hood 16” references that the opening forming the inlet 24, in the plane of the inlet 24, is spaced farther from the center plane 28 than the edge of the hood 16 in the plane of the inlet 24. The reference to the “plane of the inlet 24” is important as the hood 16 may flare out in other longitudinal locations such as shown in FIGS. 3-4. As the inlet 24 is forward facing the plane of the inlet 24 is substantially perpendicular to the center plane 28 as shown in the figures.

The air inlet 24 is positioned directly above the front wheels 12 of the automobile 10 as shown. Although above and generally above are terms that are believed to be known to those of ordinary skill in the art, the following geometric description is added to provide a degree of precision to the terms in this application. The phrase that “the inlet 24 is positioned directly above the front wheel 12” refers to the positioning of the inlet 24 in a longitudinal (i.e. measured along the center plane 24) location bounded by a pair of vertical planes that are perpendicular to the center plane 28 and are tangent to the forward and rearward extent of the front wheels 12 (with the front wheels 12 aligned with the forward direction of the automobile 10), and in a vertical location above the center of the front wheels 12. The phrase that “the inlet 24 is positioned generally above the front wheel 12 defines herein a slightly broader area in that the longitudinal location of the inlet 24 is bounded by planes that are 10 degrees from vertical and are perpendicular to the center plane 28 and are tangent to the front wheels 12, whereby the two vertically extending planes define a slightly increasing area as they extend above the wheels 12.

The automobile 10 includes a windshield 30 between a pair of side posts 32. The construction of the windshield 30 and side posts 32 are conventional and well known in the art. As illustrated, the air inlet 24 of the air scoop according to a first embodiment of the present invention extends laterally beyond, and is possibly positioned laterally outside, of one side post 32 on the drivers side (United States Standard Driver Position). For precision, the term that the air inlet 24 extends beyond the side post 32 defines that the laterally outermost part of the air inlet 24 is spaced farther from the center plane 28 than the outermost part of the side post 32. The reference that the air inlet 24 may be positioned laterally outside the side post 32 defines a location of the air inlet 24 in which the innermost portion of the air inlet 24 is spaced farther from the center plane 24 than the outermost part of the side post 32. Additionally, the present invention may form the vertical centerline of the inlet 24 laterally outside of the side post 32.

The automobile 10 includes at least one pair of headlamps 34 and at least at least one side rear view mirror 36. The air inlet 24 of the air scoop according to a first embodiment of the present invention extends laterally beyond one headlamp 34 relative to the center plane 28, and preferably has the vertical centerline of the inlet 24 positioned laterally outside of one headlamp 34 relative to the center plane 28, and is possibly positioned laterally outside of one headlamp 34 relative to the center plane 28. At least the innermost lateral edge of the air inlet 24 and preferably the vertical centerline of the air inlet 24 and possibly the outermost end of the air inlet 24 is positioned laterally within an outer edge of the side rear view mirror 36 as shown in the front view of FIG. 1. In other words the outer end of the one rear view mirror 36 extends laterally beyond the inner most edge of the air inlet 24, preferably beyond the vertical centerline of the air inlet 24 and is possibly positioned laterally outside of air inlet 24 as shown. As discussed above the lateral dimensions are relative to the center plane 28. An additional reference point for the position of the air inlet 24 is relative to the body in the plane of the air inlet 24, wherein the body is represented by panel 26. The air inlet 24 of the air scoop extends laterally beyond of the body (panel 26) in the plane of the air inlet 24 as best shown in FIG. 2, and preferably the vertical centerline of the air inlet 24 is positioned laterally beyond the body. It is anticipated that the air inlet 24 of the air scoop of the present invention could be positioned laterally beyond the body whereby the innermost edge of the air inlet 24 is laterally beyond of the outermost portion of body (panel 26) in the plane of the air inlet 24.

In the vertical dimension the air inlet 24 of the air scoop according to a first embodiment of the present invention extends vertically below an uppermost edge of the rear view mirror 36 and below a lowermost edge of the windshield 30, meaning that the lowermost portion of the air inlet 24 is below these reference points. Preferably a horizontal centerline of the air inlet 24 is positioned below an uppermost edge of the rear view mirror 36 and below a lowermost edge of the windshield 30. As shown, the air inlet 24 is vertically below the uppermost edge of the rear view mirror 36, meaning the uppermost portion of the air inlet 24 is below the referenced upper edge of the rear view mirror 36. It is anticipated that the air inlet 24 of the air scoop of the present invention could be vertically below the lowermost edge of the windshield 30, such as shown in the embodiment in FIGS. 3 and 4.

The above description attempts to define the parameters for locating the air scoop of one embodiment of the present invention relative to conventional features of the automobile 10. FIGS. 3 and 4 illustrate an automobile 100 with an air scoop according to the present invention with a different relative position of the air inlet 24 as shown. The automobile 100 is a retro style vehicle. The reference numbers for the respective elements remain the same. In this embodiment the air inlet 24 is above the wheels 12, and laterally outside the hood 16, and the body (panel 26), in the plane of the inlet 24. The inlet 24 here is below the windshield 30, but not outside of the side post 32, referenceing the inner edge of the air inlet 24. No side rear view mirror is illustrated in this concept vehicle. The vertical centerline of the inlet 24 is positioned laterally outside of the side post 32 and the inlet 24 does extend laterally outside of the side post 32.

The housing 22 may be aerodynamically shaped to minimize drag, provide such shaping does not impede internal air flow from the inlet 24 to the internal conduits 20. The housing 22 may, preferably, be directly coupled to the internal conduits 20 and associated body panel 26, with the hood 16 including appropriate cutouts to accommodate the stationary housing 22. Alternatively, the housing 22 may be coupled to the hood 12 with an associated gasket sealed coupling formed between the housing 22 and the internal conduits 20 only when the hood 16 is closed. In view of the laterally extending nature of the air scoop of the present invention the stationary housing construction is likely to be simpler, and therefore preferred.

As illustrated the air scoop of the present invention will result in little or no obstruction to the driver's vision. Even in the embodiment illustrated in FIGS. 1 and 2 the air scoop is generally positioned in the “blind spot” created by the side post 32. Further, as shown the air scoop of the present invention does not provide a physical or visual obstacle for oncoming traffic or for pedestrians. The air scoop according to the present invention further addresses many of the known problems associated with existing hood scoop designs. The air scoop of the present invention is located where it will minimize access to debris and water, as material will not be collecting on the hood 16 in front of the air inlet 24 with the present design as it does in the prior art designs (or collecting on the windshield 30 then directed to the inlet 24 as in rearward facing hood air intake designs). The total length of the air intake is generally minimal in the present invention compared to grill or door intake systems. Further some engines will have the air intake on the side making the location of the present scoop optimal from a distance standpoint. Regarding engine noise, the location of the air scoop in the present invention is believed to reduce the noise transmitted to the side of the street on the passenger's side of the automobile 10, as the opening is moved farther from that side, is not completely rebounding off of the hood 16 and is buffered by the vehicle itself. The present invention allows other known scoop features to be maintained, such as a manually operable baffle to minimize air intake through the inlet 24 that can be operated interior of the automobile such as for noise control or where the scoop is intended to be used only at high speeds. Known inlet guards, screens or grills can also be used with the present system.

Whereas particular embodiments of this invention have been described above for purposes of illustration, it will be evident to those skilled in the art that numerous variations of the details of the present invention may be made without departing from the invention as defined in the appended claims. The scope of the present invention is intended to be defined by the appended claims and equivalents thereto.

What is claimed is:

1. An external air scoop for an automobile having front and rear wheels and an internal combustion engine within a forward engine compartment having a hood for access to the engine compartment, and having an air intake for the engine, the air scoop coupled to the air intake and having an air inlet positioned laterally of the hood and generally above the front wheel of the automobile.

2. The external air scoop of claim 1 wherein the automobile includes a windshield between a pair of side posts, and wherein a vertical centerline of the air inlet of the air scoop is positioned laterally outside of one side post.

3. The external air scoop of claim 1 wherein the automobile includes at least one pair of headlamps and at least at least one side rear view mirror, and wherein the a vertical centerline of the air inlet of the air scoop is positioned laterally outside of one headlamp and laterally within an outer edge of the side rear view mirror and the air inlet extends below an upper edge of the rear view mirror.

4. The external air scoop of claim 1 wherein the air scoop in plan view extends beyond a body of the automobile and is directly above the front wheel of the automobile.

5. The external air scoop of claim 1 wherein the air inlet is round and a vertical centerline of the inlet is spaced at least 2 inches from a body of the automobile.

6. The external air scoop of claim 1 wherein the automobile includes a windshield between a pair of side posts, and wherein the air inlet of the air scoop is positioned laterally outside of one side post, and extends below a lower edge of the windshield.

7. An internal combustion engine system for an automobile having front and rear wheels and a forward engine compartment having a hood for access to the engine compartment, the engine system comprising
An engine mounted within the engine compartment; and
An air intake system coupled to the engine, the air intake system including an air scoop having an air inlet positioned generally laterally of the hood and generally above the front wheel of the automobile.

8. The internal combustion engine system of claim 7 wherein the automobile includes a windshield between a pair of side posts, and wherein a vertical centerline of the air inlet of the air scoop is positioned laterally outside of one side post.

9. The internal combustion engine system of claim 7 wherein the automobile includes at least one pair of headlamps and at least at least one side rear view mirror, and wherein a vertical centerline of the air inlet of the air scoop is positioned laterally outside of one headlamp and laterally within an outer edge of the side rear view mirror and the air inlet extends below an upper edge of the rear view mirror.

10. The internal combustion engine system of claim 7 wherein the air scoop in plan view extends beyond a body of the automobile and is directly above the front wheel of the automobile.

11. The internal combustion engine system of claim 7 wherein the air inlet is round and the inlet is spaced 2-4 inches from a body of the automobile.

12. The internal combustion engine system of claim 7 wherein the automobile includes a windshield between a pair of side posts, and wherein the air inlet of the air scoop is positioned laterally outside of one side post, and extends below a lower edge of the windshield.

13. The internal combustion engine system of claim 7 wherein the automobile includes a windshield between a pair of side posts, and wherein the air inlet of the air scoop is positioned below a lower edge of the windshield and laterally within an outer edge of the body of the vehicle in front view.

14. An automobile having
front and rear wheels;
a forward engine compartment having a hood for access to the engine compartment;
An engine mounted within the engine compartment; and
An air intake system coupled to the engine, the air intake system including an air scoop having an air inlet positioned generally laterally of the hood and generally above the front wheel of the automobile.

15. The automobile of claim 14 wherein the automobile further includes a windshield between a pair of side posts, and wherein a vertical centerline of the air inlet of the air scoop is positioned laterally outside of one side post.

16. The automobile of claim 14 wherein the automobile further includes at least one pair of headlamps and at least at least one side rear view mirror, and wherein the air inlet of the air scoop is positioned laterally outside of one headlamp and laterally within an outer edge of the side rear view mirror and extends below an upper edge of the rear view mirror.

17. The automobile of claim 14 wherein the air scoop in plan view extends beyond a body of the automobile and is directly above the front wheel of the automobile.

18. The automobile of claim 14 wherein the air inlet is round and the inlet is spaced 2-4 inches from a body of the automobile.

19. The automobile of claim 14 wherein the automobile further includes a windshield between a pair of side posts, and wherein the air inlet of the air scoop is positioned laterally outside of one side post, and extends below a lower edge of the windshield.

20. The automobile of claim 14 wherein the automobile further includes a windshield between a pair of side posts, and wherein the air inlet of the air scoop is positioned below a lower edge of the windshield and laterally within an outer edge of the body of the vehicle in front view.
